(19) United States
(12) Patent Application Publication
(10) Pub. No.: US 2018/0077739 A1
(43) Pub. Date: Mar. 15, 2018

(54) TELECOMMUNICATION NETWORK

(71) Applicant: StarLeaf Ltd., London (GB)

(72) Inventors: Nicholas Ian Moss, Harrow Middlesex (GB); William Muir MacDonald, Los Gatos, CA (US)

(21) Appl. No.: 15/702,566

(22) Filed: Sep. 12, 2017

(30) Foreign Application Priority Data
Sep. 13, 2016 (GB) 1615548.3

(51) Int. Cl. H04W 76/02; H04L 12/46; H04L 29/06

(52) U.S. Cl. CPC H04W 76/02; H04W 80/04; H04L 63/0272; H04L 12/4641

(57) ABSTRACT

Disclosed embodiments relate to a shared computing system for use in telecommunications between end-point telecommunication devices of a telecommunications network. In some embodiments, the computing system includes a plurality of session border controllers and a telecommunication connection controller. The border controllers can be configured to be couplable to end-point telecommunication systems, and to send and receive data to and from them. The telecommunication connection controller can be arranged to route media traffic between the border controllers and to establish connections between them so as to transfer media traffic from one end-point telecommunication system to another. A telecommunication network, a method of telecommunications, a computer program and a computer-readable medium can include the shared computing system.

### CROSS-REFERENCE TO RELATED APPLICATIONS

This application claims the benefit of the Great Britain Application No. 1615548.3, filed on Sep. 13, 2016, which is hereby incorporated by reference in its entirety.

### FIELD OF THE DISCLOSURE

The present disclosure relates generally to telecommunications between end point telecommunication devices. More particularly, embodiments of the disclosure relate to an improved network for unified communications.

### BACKGROUND DISCLOSURE

Business organisations today are increasingly employing individuals based at a number of different physical locations. For instance, any one organisation may have a plurality of separate offices, nationally or internationally. Flexible working means that it is also becoming common for employees to work partly or entirely from their homes. In such a scenario, and particularly in situations where collaboration between employees is desirable or even imperative, it is important for an organisation's various sites to be suitably interconnected. Indeed, even meetings with customers or clients external to the organisation may be conducted virtually, so as to save on the time and cost of travel for example.

Generally, an organisation will employ a dedicated team of IT specialists who may be responsible, amongst other things, for establishing and maintaining those interconnections and ensuring that the systems in place at individual sites can each reach and interoperate with those of any other site. This is not difficult to achieve with simple systems such as the Voice over Internet Protocol (Voice over IP, or VoIP) that realises delivery of voice communications over Internet Protocol (IP) networks such as the public Internet. VoIP is a well-known, mature technology and interoperability has been established. FIG. 1 shows, schematically, a prior art network that may be used to implement VoIP.

In the drawing of FIG. 1, a network includes three end-user computing systems, each at a different physical site and each connected to the public Internet 10 by a link 15. As is well-known to those of skill in the art, the computing system at each site may include a local telephone system 16, connected to individual telephones 12 on the site's local area network. Further shown in FIG. 1 are firewalls 11 for controlling the flow of data traffic into and out of each site, and session border controllers (or simply ‘border controllers’) 13.

The border controllers are configured to control the signalling between individual sites, and each is arranged to route voice traffic from the corresponding local telephone system to the organisation's other sites over the Internet 10. The term ‘border’ as used herein refers to a point of demarcation between one part of a network and another: the job of the border controller for a given site is to control the data flows into and out of that site during a call or session between the site and a second, remote site. Given that task and in view of firewalling considerations, it is often convenient for each border controller to straddle the respective firewall as discussed below.

As shown by the dashed lines 14 in FIG. 1, permanent or on-demand connections are established between individual border controllers to achieve this traffic routing. In known setups such as that of FIG. 1, successful call routing can require either a full mesh of connections between individual border controllers, or a directory server such as an H.323 Gatekeeper to oversee the call mapping and any necessary translation services.

However, end-users are steadily becoming more demanding in terms of the functionality required of inter-site communications systems. The desire for additional services such as video conferencing, screen sharing, presence and instant messaging, among others, and the resulting need to share multiple streams of data simultaneously, can make the task of establishing suitable inter-site connectivity significantly more challenging. In addition, these services are largely immature, and are either incompatible or, where supposedly compatible, are not cleanly inter-operable. As is known in the art, the integration of these various real-time and non-real-time communication services (referred to herein generally as ‘unified communications’, or UC) can require a more carefully controlled Wide Area Network (WAN) structure than does VoIP alone, as well as the transfer, simultaneously, of multiple streams of data (for example, a video conference may involve screen sharing in addition to the transfer of audio and video data). The complexity of a network such as that of FIG. 1, when adapted for UC, can also increase dramatically with the number of sites. In particular, proper call routing within the network of FIG. 1 is known to require access, by the border controllers 13, to significant information about the border controllers on other sites. In networks including a large number of individual sites, in particular, this can result in a correspondingly large number of dynamic VoIP connections needing to be maintained simultaneously. Each border controller 13 will typically straddle the respective firewall 11; that is, the border controllers are connected both to the Internet 10 for connection with one another, and to the local area networks of their respective sites for communication with end-systems 16. This setup can be difficult to configure and to maintain.

A further challenge to the successful implementation of UC is the potential introduction of unexpected network technologies that may occur, for example, during virtual conferencing with external entities or as a part of a company acquisition. This step-change in complexity presents a considerable challenge to those implementing and overseeing the interconnections needed between sites.

Furthermore, according to known networks such as that of FIG. 1 media resources are typically located at particular, well-known locations or at an organisation's individual sites. Thus if, for instance, a given scenario requires a conference bridge, then that bridge may be set up on a specific site, on an ad hoc basis, to serve the immediate need. This restriction to hard-coded addresses or routes can make it difficult for networks such as that of FIG. 1 to handle roaming users, whose IP addresses may be constantly changing. Additionally, while this approach can work well for small networks, in which resources are used lightly, it does not scale well.

The admission to a conference call, hosted on a conventional telecommunications network, of a user external to the organisation hosting the network can also be problematic. In particular, changes typically need to be made the border controllers local to some or all sites participating in the call, so as to allow them to recognise the new user and to grant the relevant permissions.

### SUMMARY

We have appreciated that it would be desirable to provide a telecommunications arrangement that is suitable for UC, which can simplify the configuration of on-site communication server trunks and which may address some or all of the difficulties just outlined.

Embodiments of the disclosure address the desire for, and the challenges presented by, UC between multiple sites by providing a centralised, outsourced system or service for handling the requirements of inter-site trunking of UC systems.

The disclosure is defined in the independent claims to which reference should be made. Additional features are set out in the dependent claims.

According to some embodiments, there is provided a shared computing system for use in telecommunications between end-point telecommunication devices, the computing system comprising a plurality of border controllers and a telecommunication connection controller. The border controllers are each configured to be couplable to at least one remote end-point telecommunication system; and the telecommunication connection controller is configured such that, when media traffic is received by one, source border controller of the plurality of border controllers, the telecommunication connection controller routes the media traffic to another, target border controller of the plurality of border controllers and establishes a telecommunication connection between the source border controller and the target border controller to transfer the media traffic to a second, target end-point telecommunication system.

According to some embodiments, there is provided a network for telecommunications between end-point telecommunication devices, the network comprising a plurality of end-point telecommunication systems and a shared computing system. The computing system comprises a plurality of border controllers, each communicatively coupled to at least one of the plurality of end-point telecommunication systems, and a telecommunication connection controller configured such that, when media traffic is received by one, source border controller of the plurality of border controllers, the telecommunication connection controller routes the media traffic to another, target border controller of the plurality of border controllers and establishes a telecommunication connection between these two border controllers to transfer the media traffic to a second, target end-point telecommunication system.

According to some embodiments, there is provided a method for telecommunications between end-point telecommunication devices, the method comprising the steps of receiving, at one, source border controller within a shared computing system, media traffic from a source end-point telecommunication system communicatively coupled to the source border controller; routing the media traffic to another, target border controller within the shared computing system; and using a telecommunication connection controller within the shared computing system to establish a communication connection between the source border controller and the target border controller.

The term ‘shared’ is used herein to refer to a centralised, distributed (or ‘cloud’) computing arrangement. Cloud resources are typically geographically separate from end-user systems, are shared by multiple users and are dynamically re-allocated per demand. With cloud computing, those multiple users can access a single server, which may be distributed over a number of central processing units (CPUs), to retrieve and update their data.

As used herein, the term ‘source’ is used in relation to a site, or to the corresponding end-point telecommunication system, at which a call originates. The term ‘source border controller’ is intended to denote the border controller within the cloud to which that call is routed. Similarly, the term ‘target’ is used to refer to the local system to which a call is to be directed and/or to the corresponding border controller used to realise that call routing. Embodiments of the disclosure include the advantage that an organisation may need to maintain only a single (or a small number of) connection(s) with a cloud border controller (or controllers) connected to the public Internet. In other words, by implementing the border control of the network wholly in front of and, in some cases, remote from individual network sites, the need for a full mesh of permanent or on-demand connections between border controllers local to each site may be reduced or eliminated.

Advantageously, this can also simplify the firewalling requirements of networks in accordance with the disclosure. In particular, since the border controller(s) to which each site is coupled may have a fixed geographical location, the interconnect can be sufficiently simple that the need for site-specific servers arranged to straddle a respective firewall, where this is in place, can be reduced or eliminated: the firewall at each site may need configuring only to allow connections to the relevant border controller or controllers. This is in contrast with existing networks of the sort shown in FIG. 1 in which, as mentioned, firewalls typically need to be able to cope with large numbers of changing and dynamic connections.

Implementation of session border controllers using shared resources can also lead to improvements in coherence and efficiency, as well as to reduced power consumption and, thus, environmental impact.

Additionally, in accordance with the disclosure the invitation of guest users (that is, end-point telecommunication systems that are geographically separated from the locations of the end-point telecommunication systems of the network of the disclosure) to participate in a conference call or other communication may be more easy than has previously been the case. In particular, guests may be invited to a call without the need for any changes of the sort described above to the configuration of an organisation's physical network apparatus and systems. This is because all necessary steps to accommodate the guest may be implemented in the cloud-based systems of the disclosure: the inventive network may remain responsive to the guest, and may handle the media using efficient routing methods. Similarly, embodiments of the disclosure may also facilitate interoperation between UC systems of separate organisations, through a shared UC trunking service to which they are both (or all) attached. The cloud network can include knowledge of the systems and capabilities of the local networks of both organisations, and can therefore allow the best possible interaction experience between those two systems to be achieved without connections being reduced to the feature set that is negotiable through standards-based UC protocols.

Furthermore, owing to the small number of fixed external connections from the end-point telecommunication systems of the inventive network, a simple, scalable strategy may be provided for increasing the number of sites that are (permanently or otherwise) interconnected. In particular, the need for local hardware to be aware of dial plans, of how directory numbers map to sites, or even of the number or location of other sites can be eliminated. Instead, the end-point telecommunication systems need only to be aware of the location of their point of presence in the cloud.

In some embodiments of the disclosure, that point of presence takes the form of an anycast address, the border controllers being configured according to an anycast network addressing protocol. The use of network technologies such as anycast addressing can further simplify the inclusion of additional geographical points of presence or increases in capacity without compromising or affecting the configuration of existing network sites, by allowing designers to implement any necessary changes as changes to the topology of the cloud servers. Anycast addressing and other similar techniques can additionally allow for particularly simple configuration of local end-systems and firewalling arrangements.

Anycast addressing may also facilitate the connection to the telecommunication network of a user roaming across the globe, changing continuously both his geographical location and his IP address. In particular, anycast addressing may realise that connection using the most efficient point-of-presence and path in view of the user's instantaneous location and IP address, all the while leaving firewalling rules unchanged.

More generally, by using cloud techniques the disclosure may permit the shared use of geographically local media resources and efficient trunking of calls without being tied to hard-coded addresses or routes in the same way as existing configurations. For example, conference bridges from across the world may be allocated according to the location of the sites in a particular conference and the availability of resources.

Further, connection to the cloud service of the disclosure following an anycast addressing protocol can simplify and improve the provisioning of failover systems. In particular, should one border controller or the connection to it fail, that instance can be removed from the anycast routing, and the connected end-point system simply connected to the next most appropriate controller given its point of presence, without any intervention or additional configuration. To assist with this, the border controllers in some embodiments may be monitored by external monitoring systems, which may detect automatically the failure of a border controller and instruct its removal from the anycast pool so as to prevent any future connection to it.

In some embodiments, two or more of the end-point telecommunication systems may be configured to operate according to differing telecommunication protocols. In those cases, the telecommunication connection controller is preferably configured to be interoperable with those different protocols. For example, the telecommunication connection controller may operate according to a unified telecommunication protocol that includes a superset of the functionalities of the two or more different telecommunication protocols. Preferably, each border controller is then configured to map the telecommunication protocol of the or each end-point telecommunication systems to which it is coupled into the unified telecommunication protocol, and vice versa.

The disclosure in these embodiments may advantageously facilitate the interconnection, on the same corporate telecommunication network, of individual sites or devices that may otherwise be incompatible for telecommunications. Similarly, it may become easier for users from outside the telecommunication network to join a video conference hosted on the telecommunication network.

Further, transcoding of video in these embodiments may be made more efficient with respect to existing arrangements.

In some embodiments of the disclosure, the coupling between at least one border controller and a respective end-point telecommunication system is tunneled through a virtual private network (VPN). In other words, the streams of control and media packets passed between the end-system and the border controller may be encapsulated within another packet stream. This may simplify the firewalling of the end-system still further. In particular, since all media and control packets appear to the firewall of the end-system as a single VPN stream, it may be simpler to configure that firewall in such a way as to allow that stream to pass through it. This can be advantageous when compared to the complex assortment of media and control streams that are typical in standards-based UC systems such as SIP or H.323, each of which must be managed and transferred separately.

Additionally, as will be discussed below the use of one or more VPNs to tunnel network packet streams may assist in resolving network address incompatibility or in transferring packets that may not otherwise be routable across the public Internet.

The network packets may optionally be encrypted within the wrapping packet stream. This can provide enhanced privacy and security in some embodiments.

In some embodiments, multiple bonded VPNs may be used to route traffic away from an end-point telecommunication system over multiple network paths. By maintaining multiple virtual tunnels between the end-point telecommunication system and the border controller, each travelling through a different physical infrastructure, a single logical connection may be achieved by making use of whatever links are available. Thus, the disclosure in these embodiments may advantageously provide still further improved failover with respect to conventional networks: if one link fails, the connection continues to operate over the remaining links. In other words, the burden of redundancy is moved off the end-system onto the VPN. This sort of arrangement can be difficult to implement in traditional full mesh connections simply because of the number of interconnects that require duplication if true redundancy is to be achieved.

Preferably, at least one of the end-point telecommunication systems is coupled to two or more of the border controllers, to provide both load sharing and redundancy. These advantages may be more easily realised according to the disclosure than has previously been possible, since traditional video-conferencing arrangements typically tie functionality to physical devices at physical locations, rather than providing a shared pool of resources that can be connected to at will.

According to embodiments of the disclosure, the call control system may include a centralised management interface with which designers and engineers can interact so as to configure the behaviour of all border controllers for a particular organisation from a single, centralised location. It may also include a management application programming interface (API) to allow corporate systems to control many aspects of the UC network across the relevant sites. This centralised management can become considerably more easy to achieve than is the case when a network architecture of the sort shown in FIG. 1 is adopted, in which configuration is typically achieved by configuring each of the UC servers and border controllers independently.

### BRIEF DESCRIPTION OF THE DRAWINGS

Embodiments of the disclosure will now be described, by way of enabling example only, with reference to the accompanying drawings in which:

FIG. 1 is a schematic diagram of a known inter-site conferencing arrangement according to the prior art; and

FIG. 2 is a schematic diagram of a telecommunication network according to some embodiments.

### DETAILED DESCRIPTION

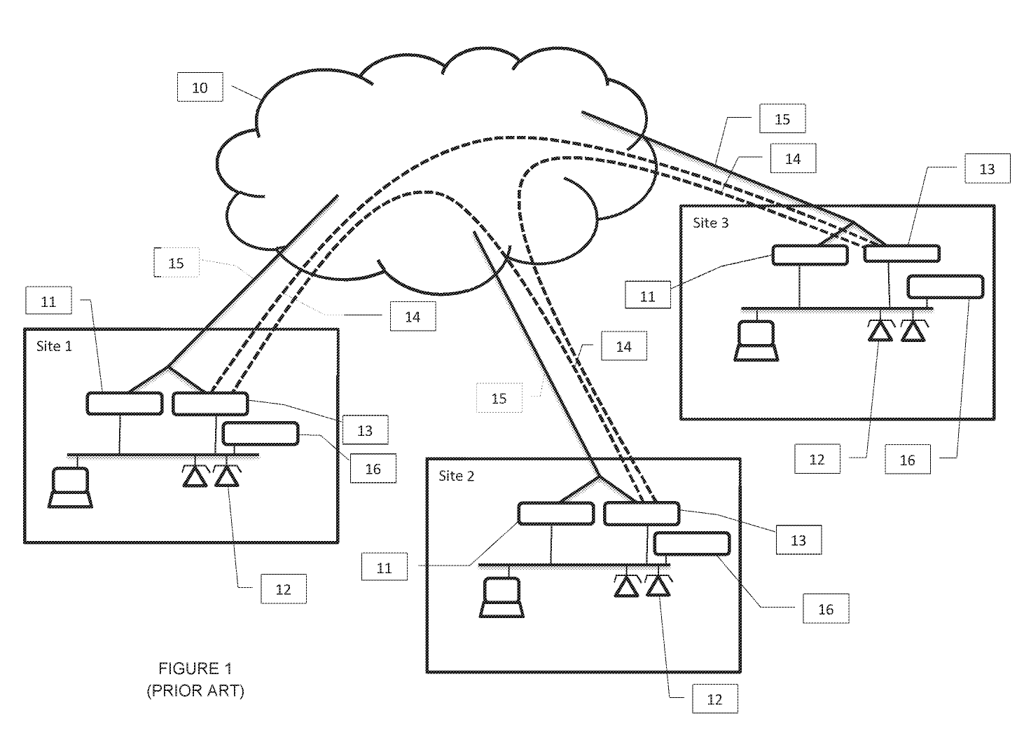

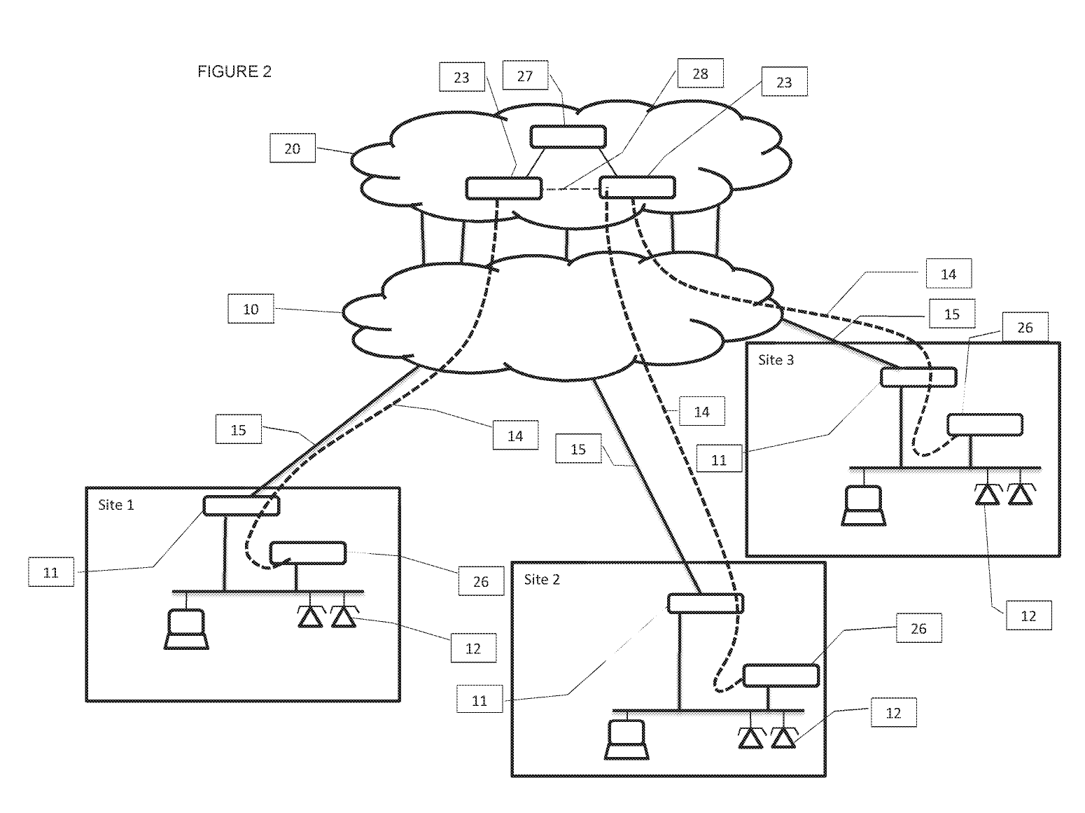

An example telecommunication network will now be described with reference to FIG. 2. In overview, the network in some embodiments includes (similarly to the known network of FIG. 1) three local computing systems at respective sites 1, 2 and 3. Each of those systems is connected to the Internet 10 by a link 15 and may include end-point devices such as telephones 12. Furthermore, the flow of traffic into and out of each system is again governed by a dedicated firewall 11.

Though depicted and discussed herein in with reference to the public Internet, examples of the present disclosure are not limited to arrangements including a connection to that network, and any WAN technology could be used. For example, the connections required to realise some embodiments of the disclosure may instead be implemented through Multiprotocol Label Switching (MPLS) technology.

However, differently from the local border controllers 13 shown in FIG. 1, configured to route calls to and from respective telephone systems 16, the example telecommunication network provides border controllers 23 that are implemented as part of a cloud trunking service 20, communicatively coupled by one or more connections to the Internet 10. As shown in FIG. 2, each cloud border controller 23 is in communication with local UC servers 26 at one or more of the organisation's individual sites 1, 2, 3 via a trunk (or trunks) 14, configured to pass through the firewall 11 of the corresponding site(s).

The border controllers 23 are under the control of a shared (or centralised) but distributed call control system 27, and are in mutual communication through an interconnect 28, which may be set up under the control of the call control system as discussed below.

Various aspects of the network of FIG. 2 and their operation will now be described in further detail.

As mentioned above, call routing between individual, physically remote sites is implemented through a cloud infrastructure 20, rather than by dedicated border controllers that are installed as part of an organisation's equipment at each premises as in the prior art. Thus, those border controllers (13; FIG. 1) may be removed, and each UC server re-configured to be connected by an appropriate trunk (or trunks) 14 to one or more border controllers 23 within the cloud computing system 20. In other words, the network of FIG. 2 replaces the full mesh of permanent or on-demand inter-site trunks of previous arrangements with a single, fixed external connection from each site to a new, cloud-implemented border controller.

As already mentioned, one consequence of the fixed and centralised location of the border controllers 23 is that the interconnections of an organisation's end-systems may be sufficiently simple that the need to configure elements of those local networks in such a way as to straddle the corresponding firewall can be reduced. That is, each firewall needs only to be configured to allow connections between the respective UC server 26 and the relevant border controller or controllers. Thus, while the session border controllers 23 are situated entirely in front of the firewalls 11, each UC server of the network of FIG. 2 is situated wholly behind the respective firewall 11, through which it is connected to the cloud trunking service 20.

In operation, a call originating at a local telephone 12 is initiated to the local UC server 26. If the called party number or address is not recognised as that of a local user, server 26 understands that the call is to an off-site destination, and routes the call across the trunk 14 to one of the cloud border controllers 23. Each border controller is configured to notify the call control system 27 of all incoming calls. Accordingly, the call control system 27 determines the desired destination of the call based on the identification of the incoming trunk and the target directory number or address, and determines which border controller is responsible for the target site. This may be done, for example, using a call control server (or a network of call control servers) that is aware of the dial plan, of which extensions are represented on which site, and of which border controller(s) includes (or have) a connection to the relevant site.

The call control system 27 then initiates a connection 28, within the cloud infrastructure, between the two border controllers. This connection may be realised in a number of ways and using whatever physical resources are required to meet quality of service guarantees and/or are available to use without impacting on the service level provided to other users, and the most suitable implementation will depend on the nature of the network as a whole in any given instance. To give an example, the connection may take the form of streams of control and media IP packets across the public Internet 10. Alternatively, a virtual private network (VPN) may be established between the border controllers to encapsulate the control and media packets within another packet stream. In some examples, a physical line may be leased between pairs of border controller devices. In yet further examples, where an MPLS arrangement is adopted the connection may be a channel through the corresponding network, which may carry a collection of streams or a VPN. In some cases, a combination of some or all of the above alternatives may be adopted.

Furthermore, the connection 28 may be implemented using any protocol that is convenient for the designers. This may be a standard protocol, such as H.323 or Session Initiation Protocol (SIP), or could instead be an extended version of those known protocols or even a bespoke, proprietary protocol, as discussed below.

However a connection between the border controllers is established, the target border controller then establishes a trunk to the destination site, passing the call through the firewall and to the end-point UC server where it is then passed on to the target telephone in the standard manner.

The call control system 27 in this example includes a centralised management interface and a management API (not shown in FIG. 2). As mentioned above, both of these functionalities may make centralised configuration, modification and management of individual sites and their hardware more easy with respect to the prior art setup of FIG. 1. In other words, control and management of an organisation's telecommunication network may be outsourced to a centralised control location, from where any necessary modifications and/or upgrades to the border controllers for all sites may be made, possibly by a third party.

The border controllers 23 of the network shown in FIG. 2 need not be limited to function according to any one particular protocol, but may be interoperable with many different protocols. Although multi-protocol border controllers exist in the art, integration of these can be made difficult by the need to be able to convert every attaching protocol to every other. In this example, a new, proprietary protocol for communication between border controllers can facilitate such an arrangement. Here, a protocol for communication on the call-control side of the border controllers includes a superset of the functionality of all the protocols that are needed by the connecting devices 11, 12, 26. Each type of transaction in the public protocols corresponds to an equivalent type of transaction in the new, unified (or global) protocol, and each border controller is then configured to map transactions on the end-user side to their equivalents in the unified protocol. In some embodiments, features in the protocols that are not used may be excluded, or the number of options in them may be restricted, to simplify the mapping to the global protocol.

Thus, the interconnection, on the same corporate video network, of individual sites that may be configured according to differing communication technologies is facilitated. When a site attaches to a border controller, the border controller routes the call through the cloud infrastructure by translating the protocol of the incoming connection into the unified protocol. Similarly, the communication is then translated again by the target border controller before being passed through the appropriate trunk to the destination site, so as to arrive at that site in a format that is suitable for the local equipment and configuration. As also mentioned above, a further consequence of the enhanced proprietary communication protocols between border controllers, together with their knowledge of an organisation's service level agreements, the available bandwidth on trunks into each end-system and traffic sharing the cross-cloud interconnections 28, is that embodiments of the disclosure allow a more efficient transcoding of video to be achieved.

The network of some embodiments of FIG. 2 is configured according to an anycast addressing protocol, with the point of presence of each end-point telecommunication system taking the form of an anycast address. As is known to those of skill in the art, anycast is a technology that allows several cloud-based servers to exist with the same IP address, with packets to that address being routed to the closest instance of that address based on the sending user's geographical location. In the event of a failure of the relevant border controller or of the connection to it, the user is then simply re-connected to the next geographically closest instance as appropriate: another server will take over handling of the necessary connections without any changes to the configuration of the user's equipment. In the network of FIG. 2, the connections 14 between local UC servers 26 and border controllers 23 are tunneled through a VPN, with all network and control packets being encapsulated within another packet stream. In this case, since all media and control packet streams appear to the firewall 11 as a single VPN stream, it may be simpler to configure that firewall in such a way as to allow those control streams to pass through. Since only one VPN is necessary per site, and because connection is always to the same fixed location (for example, to a given cloud border controller 23), configuration of the firewall and of the VPN becomes trivial as only one stream of packets travels through it. This can be advantageous when compared to the complex assortment of separate media and control streams that are typical in standards-based UC systems such as SIP or H.323. Moreover, the network packets for a site may, on occasion, follow a network addressing scheme that is native to local devices such as the firewall 11, the telephone 12 and the UC server 26. For instance, the addresses may be private RFC1918 addresses of the form “192.168.x.y”. These addresses may be unroutable across the public Internet, and may clash with the address ranges of other sites. In these cases, the use of a VPN may allow the safe transfer of those packets across the Internet for presentation to the appropriate border controller 23.

Here, the border controller 23 decouples the IP address of the relevant premises equipment from the IP addresses of the cloud and of any other connected sites at the same time as it translates the protocol of the UC server into the native cloud protocol as described above, to allow devices on different sites using overlapping IP address ranges to communicate with one another. For instance, a call may be established between a first endsystem, at a first site “G” and attached to a UC server there with a network-local address “192.168.1.20”, and a second endsystem at a separate site “Q” and attached to a UC server there including the same local address. In some embodiments, this is overcome by including a network identifier identifying the site to which an endsystem belongs when addressing that endsystem. For instance, in the above example the server addresses, in the unified protocol that exists between the border controllers 23 and the call control system 27, may be identified as “G:192.168.1.20” and “0:192.168.1.20”, respectively. These addresses are not real network addresses, but are sufficient to eliminate the conflict, to identify the relevant UC servers and to establish how to reach them.

Alternatively, this problem may be overcome by using MPLS to provide a dedicated connection between the site in question and the border controller on which the addressing scheme of that site is used. Ultimately, both of these solutions may further simplify the configuration by allowing the IP addressing scheme of a site to be extended out to the border controller. This ensures that the IP addressing scheme of the UC network fits well with that of the rest of the site.

Embodiments of the present disclosure include been described. It will be appreciated that variations and modifications may be made to the described embodiments within the scope of the present disclosure. Various components illustrated in the figures may be implemented as hardware and/or software and/or firmware on a processor, ASIC/FPGA, dedicated hardware, and/or logic circuitry. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1-41. (canceled)

42. A shared computing system for use in telecommunications between end-point telecommunication devices, the shared computing system comprising:
a plurality of border controllers configured to be communicatively couplable to at least one end-point telecommunication system; and
a telecommunication connection controller configured to, when media traffic is received by a source border controller of the plurality of border controllers, route the media traffic to another target border controller of the plurality of border controllers and establish a telecommunication connection between the source border controller and the target border controller,
wherein the plurality of border controllers are further configured to be communicatively coupled to one or more end-point telecommunication devices within each respective end-point telecommunication system through a telecommunication server of each end-point telecommunication system,
wherein when two or more end-point telecommunication systems are configured to operate according to differing telecommunication protocols, the telecommunication server is configured to operate according to a unified telecommunication protocol that includes a superset of functionalities of the two or more different telecommunication protocols.

43. The shared computing system according to claim 42, wherein the plurality of border controllers are configured to appear in front of a firewall of each respective end-point telecommunication system.

44. The shared computing system according to claim 42, wherein at least one of the plurality of border controllers is configured to translate the telecommunication protocols of the end-point telecommunication systems to and from the unified telecommunication protocol.

45. The shared computing system according to claim 42, wherein one or more of the plurality of border controllers is configured to operate according to an anycast network addressing protocol.

46. The shared computing system according to claim 42, wherein the plurality of border controllers are configured to be coupled to end-point telecommunication systems through a virtual private network, VPN.

47. The shared computing system according to claim 46, wherein the VPN comprises a plurality of VPNs, each configured to route media traffic using different physical devices.

48. The shared computing system according to claim 42, wherein the telecommunication connection controller is configured to establish a data stream between the source border controller and the target border controller.

49. The shared computing system according to claim 42, wherein the telecommunication connection controller is configured to establish a VPN between the source border controller and the target border controller.

50. The shared computing system according to claim 42, wherein the computing system is connected to, and communication between the border controllers and end-point telecommunication systems is through, the public Internet.

51. A network for telecommunications between end-point telecommunication devices, the network comprising:
a plurality of end-point telecommunication systems; and
a shared computing system comprising:
a plurality of border controllers, each configured to be communicatively coupled to at least one of the plurality of end-point telecommunication systems; and
a telecommunication connection controller configured to, when media traffic is received by one source border controller of the plurality of border controllers, route the media traffic to another target border controller of the plurality of border controllers and establish a telecommunication connection between the source border controller and the
target border controller,
wherein each end-point telecommunication system includes a telecommunication server and an end-point telecommunication device coupled to at least one of the plurality of border controllers through the telecommunication server,
wherein two or more of the end-point telecommunication systems are configured to operate according to different telecommunication protocols.

52. The network according to claim 51, wherein at least one of the end-point telecommunication systems further comprises a firewall arranged between the telecommunication server and each respective border controller.

53. The network according to claim 51, wherein the telecommunication connection controller is configured to operate according to a unified telecommunication protocol that includes a superset of functionalities of the two or more different telecommunication protocols.

54. The network according to claim 53, wherein at least one of the plurality of border controllers is configured to translate the telecommunication protocol of each end-point telecommunication system to and from the unified telecommunication protocol.

55. The network according to claim 53, wherein, for the unified telecommunication protocol, a network address of an endpoint telecommunication device comprises a network identifier and network-local address.

56. A method for telecommunications between end-point telecommunication devices, the method comprising:
receiving, at a source border controller within a shared computing system, media traffic from a source end-point telecommunication system;
routing the media traffic to another target border controller within the shared computing system;
establishing, using a telecommunication connection controller within the shared computing system, a communication connection between the source border controller and the target border controller;
establishing a connection between the target border controller and a target end-point telecommunication system;
sending, using the target border controller, the media traffic to the target end-point telecommunication system; and
when the source and the target end-point telecommunication systems operates according to differing telecommunication protocols, and
wherein the method further comprises:
translating the telecommunication protocol of the source end-point telecommunication system to a unified telecommunication protocol that includes a superset of functionalities of the different telecommunication protocols; and
translating the unified telecommunication protocol to the telecommunication protocol of the target end-point telecommunication system.

57. The method according to claim 56, wherein the media traffic is received through a virtual private network, VPN.

58. The method according to claim 56, wherein the media traffic is sent through a VPN.

59. The method according to claim 56, wherein a VPN comprises a plurality of VPNs, each configured to route media traffic using different physical devices.

60. The computer program for carrying out the method of claim 56.

61. The non-transitory computer-readable medium comprising instructions for carrying out the method of claim 56.
